(19) United States
(12) Patent Application Publication
(10) Pub. No.: US 2018/0045542 A1
(43) Pub. Date: Feb. 15, 2018

(54) A METHOD FOR REDUCING NOISE IN MEASUREMENTS TAKEN BY A DISTRIBUTED SENSOR

(71) Applicants: OMNISENS SA, Morges (CH); Ecole Polytechnique Federale De Lausanne, Lausanne (CH)

(72) Inventors: Jaime-Andres Ramirez-Mancilla, Vina-del-Mar (CL); Marcelo-Alfonso Soto-Hernandez, Lausanne (CH)

(21) Appl. No.: 15/560,553

(22) PCT Filed: Jun. 20, 2016
(86) PCT No.: PCT/IB2016/053658

§ 371 Date: Sep. 22, 2017

(30) Foreign Application Priority Data
Jun. 22, 2015 (CH) CH00896/15

(51) Int. Cl. G01D 5/353; G06K 9/00

(52) U.S. Cl. CPC G01D 5/35361; G01D 5/35364; G06K 9/00516; G06K 9/4652

(57) ABSTRACT

A method of sensing including the steps of, (a) acquiring measurement values using a distributed optical fibre sensor; (b) arranging the measurement values in a matrix having at least two dimensions; (c) transforming each measurement value in the matrix to a corresponding pixel value on a predefined scale of pixel values and forming an image with pixels having the corresponding pixel values, wherein each pixel in the image is positioned at a position in the image corresponding to the position of the measurement value in the matrix; (d) processing the image using an image processing algorithm so as to reduce noise in the image to provide processed image; (e) transforming each pixel value of pixels in the processed image to values to provide measurement values with reduced noise.

### FIELD OF THE INVENTION

The present invention concerns a method for reducing noise in measurements taken by a distributed sensor; and in particular relates to a method which involves representing measurements taken by a distributed sensor as an image and applying image processing techniques to reduce noise in the image and thus reduce noise in the measurements.

### DESCRIPTION OF RELATED ART

There are several methods to enhance the performance of distributed optical fibre sensors. Among those methods, there are some related to signal processing, such as optical pulse coding, wavelet transform, and Fourier transform. These techniques remove noise from a unidimensional (1D) array of data; and therefore, their use in distributed sensing requires processing every longitudinal trace (along the fibre) at each scanned frequency or time, independently from each other.

It is also known the use of wavelet transform to increase the SNR of distributed fibre sensors. However, the use of such a technique is limited to a basic unidimensional processing of independent 1D data arrays. Disadvantageously unidimensional processing of independent 1D data arrays does not consider the entire information contained in a two-dimensional representation of the measured data in a distributed fibre sensor. As an example, discrete wavelet transform has been used to denoise 1D data measurements obtained by Raman distributed temperature sensors. In addition, 1D wavelets have been used to denoise each longitudinal trace in Brillouin-based systems independently from each other, or to denoise the measured local Brillouin gain spectrum at each fibre location, or have been simply applied directly to the measurand (strain or temperature) profile along the fibre. Wavelets have also been used to denoise 1D data arrays containing the information of Rayleigh-based distributed sensors.

A fundamental point is that all methods existing in the state-of-the-art of distributed fibre sensing make use of unidimensional signal processing, which is employed to reduce noise only along a unidimensional array of data. The disadvantage of these existing methods is that they do not make full use of the entire information contained in the data measured by the sensor, and therefore they provide a limited improvement of the SNR.

One of the main features of Brillouin distributed fibre sensors is their capability to measure temperature and strain profiles along very long sensing ranges using metric spatial resolution. Over the past two decades there have been intense research activities to enhance the performance of this kind of sensors. The signal-to-noise ratio (SNR) of Brillouin optical time-domain analysers (BOTDA) has been substantially improved using advanced techniques, such as distributed Raman amplification, optical pulse coding or other kinds of signal processing, especially when those methods are combined in a single system. Among the different methods proposed in signal processing techniques, optical pulse coding, wavelets and Fourier transform are very efficient tools to remove noise from a unidimensional array of data. So far when used with Brillouin (BOTDA-BOTDR) or Rayleigh (phi-OTDR) distributed sensing, a time-domain trace based processing is required at each scanned frequency offset independently from each other. A 3D map of the Brillouin gain spectrum (BGS), or cross-correlation spectral peak in a Rayleigh measurement versus distance can thus be obtained with an improved SNR after processing each time-domain trace.

Although methods such as time-frequency codes take advantage of the double scanning (this means the scanning of each fibre position with a given spatial resolution and the scanning of the pump-probe frequency detuning) required in a Brillouin sensor, the SNR enhancement is given by the capability of the code to reduce noise in a unidimensional array of data whilst depending on very specific and challenging hardware.

It is an aim of the present invention to obviate or mitigate at least some of the disadvantages of the existing method of distributed sensing. In particular it is an aim of the present invention to provide a distributed sensing method which can provide measurements with improved signal to noise ratio.

### BRIEF SUMMARY OF THE INVENTION

According to the invention, there is provided a method of sensing comprising the steps of, (a) acquiring plurality of measurement values using a distributed optical fibre sensor; (b) arranging the plurality of measurement values in a matrix having at least two dimensions; (c) transforming each measurement value in the matrix to a corresponding pixel value on a predefined scale of pixel values to form an image; (d) processing the image using an image processing algorithm so as to reduce noise in the image to provide processed image; (e) transforming each pixel value of pixels in the processed image to values to provide a plurality of measurement values with reduced noise.

It should be understood that in the present invention the term “image” includes a matrix comprising numbers which represent pixel (i.e. an image matrix); such as, for example, a matrix comprising pixel intensity values from a predefined color intensity scale. In other words the term “image” is not limited to the visible embodiment of an image which can be seen by a human eye, but rather the term also includes a mathematical embodiment of an image which is typically used by processing algorithms.

It should also be understood that image processing includes 2-D image processing, 3-D image processing, or video processing (i.e. processing a sequence of 2-D images. Likewise an image processing algorithm includes a 2-D image processing algorithm, 3-D image processing algorithm, or a video processing algorithm.

According to the preferred embodiment the method comprises the steps of, acquiring plurality of measurement values using a distributed optical fibre sensor; arranging the plurality of measurement values in a matrix having at least two dimensions; transforming each measurement value in the matrix to a corresponding value on a predefined scale of pixel values, to form an image matrix which is representative of an image; processing the image matrix using an image or video processing algorithm so as to reduce noise in the image matrix to provide processed image matrix; transforming each pixel value of the processed image matrix to values to provide a plurality of measurement values with reduced noise.

The method may further comprise the step of processing the measurement values with reduced noise to determine a characteristic of an optical fibre of the distributed optical fibre sensor.

The method may further comprise the step of processing the measurement values with reduced noise to determine at least one of temperature, pressure and/or strain in an optical fibre of the distributed optical fibre sensor.

The step of transforming each pixel value of pixels in the processed image to values to provide a plurality of measurement values with reduced noise, may comprise transforming each pixel value of pixels in the processed image to values having units of measurements equivalent to the units of the measurement values acquired in step (a).

The step of transforming each measurement value in the matrix to a corresponding pixel value on a predefined scale of pixel values, may comprise performing a linear transformation, non-linear transformation or inverse transformation, to a corresponding value on a predefined scale of pixel values.

The step of transforming each entry of the matrix to a corresponding value on a predefined scale of pixel values may comprise, transforming each entry of the matrix to a corresponding value on the predefined scale of pixel values, wherein the highest measured value is mapped to the highest value in the predefined scale of pixel values, and the lowest measured value is mapped to the lowest value in the predefined scale of pixel values.

The measured values having values between the highest and lowest measured values may be mapped to corresponding relative pixels values in the predefined scale of pixel values, wherein for each of said measured values the corresponding relative pixels value is such that the ratio of that measured value pixel value to the highest measured value acquired in step (a) is equal to the ratio between the corresponding relative pixel value and the highest pixel value on the predefined scale of pixel values.

The predefined scale of pixel values may be a scale of color intensities.

The predefined scale of pixel values may be a colour scale.

The predefined scale of pixel values may be a grey-scale.

The step of transforming each pixel value of the pixels of the processed image back to values, may comprise performing a linear transformation, non-linear transformation or inverse transformation.

The step of transforming each pixel value of the processed image back to measurement values, comprises mapping the highest pixel value in the processed image to the highest measured value acquired in step (a), and mapping the lowest pixel value in the processed image to the lowest measured value acquired in step (a).

In an embodiment, for each of the pixel values of each of the pixels in the processed image which are between the highest and lowest pixel values to a measured values, the method comprises, mapping that pixel value to a corresponding measurement value wherein the corresponding measurement value is such that the ratio of the pixel value to highest pixel value is equal to the ratio of the corresponding measurement value to the highest measured value acquired in step (a).

The step of arranging the plurality of measurement values in a matrix having at least two dimensions may comprise, positioning each of the measurement values in the matrix according to the values of at least two variables associated with that respective measurement value.

The method may further comprise the step of measuring frequency of a backscatter signal and/or distance from a predefined end of the optical fibre of the sensor at which the measurement value was acquired.

The step of arranging the plurality of measurement values in a matrix having at least two dimensions may comprise, positioning each of the measurement values in the matrix according to the values of at least two variables associated with that respective measurement value, and wherein said at least two variables associated with that respective measurement value comprise frequency and position along the sensing fibre at which the measurement value was taken.

The step of acquiring a plurality of measurement values using a distributed optical fibre sensor may comprise acquiring a plurality of Brillouin response values, and the step of arranging the plurality of measurement values in a matrix having at least two dimensions comprises arranging the acquired Brillouin response values in a matrix having two dimensions, where each Brillouin response value is arranged in the matrix according to the position along a sensing fibre at which the respective Brillouin response value was acquired, and according to a frequency-offset at which the respective Brillouin response value was acquired.

The step of acquiring plurality of Brillouin response values may comprise acquiring plurality of Brillouin gain values and/or acquiring plurality of Brillouin loss values.

The step of acquiring a plurality of measurement values using a distributed optical fibre sensor, may comprise, using a Brillouin distributed optical fibre sensor to acquire a plurality of Brillouin response values, at different frequency shifts between the pump signal and backscattered signal, at different positions along an optical fibre of the Brillouin distributed optical fibre sensor; and

wherein the step of arranging the plurality of measurement values in a matrix having at least two dimensions comprises arranging the acquired Brillouin response values in a matrix having two dimensions, and

wherein the acquired Brillouin responses are positioned in the matrix according to the frequency shifts between the pump signal and backscattered signal and the position along an optical fibre at which that Brillouin response was measured.

The acquiring plurality of measurement values using a distributed optical fibre sensor may comprise acquiring the response of Rayleigh backscattering, and the step of arranging the plurality of measurement values in a matrix having at least two dimensions comprises arranging the acquired response of Rayleigh backscattering, in a matrix having two dimensions. Preferably each response of Rayleigh backscattering is positioned in the matrix according to position along the sensing fibre at which said response of Rayleigh backscattering was measured and according to an optical frequency at which said response of Rayleigh backscattering was measured.

The step of acquiring the response of Rayleigh backscattering may comprise acquiring the intensity of Rayleigh backscattering.

The method may further comprise the step of recording the time over which all of the plurality of measurement values are acquired.

The method may further comprise the step using said image and the recorded time at which each measurement value is acquired to generate a 3-D image matrix which is representative of a 3-D image or video (i.e. a sequence of 2-D images); and wherein the step of processing the image using an image processing algorithm, comprises processing the 3-D image or video using an 3-D image or video processing algorithm.

The recorded time may be one of said at least two variables associated with that respective measurement value.

The acquiring plurality of measurement values using a distributed optical fibre sensor may comprise acquiring response of Raman backscattering, and the step of arranging the plurality of measurement values in a matrix having at least two dimensions comprises arranging the acquired response of Raman backscattering in a matrix having two dimensions, wherein said recorded time is one of said at least two variables associated with that respective measurement value.

In an embodiment the acquiring plurality of measurement values using a distributed optical fibre sensor comprises acquiring the response of Rayleigh backscattering, and the step of arranging the plurality of measurement values in a matrix having at least two dimensions comprises arranging the acquired response of Rayleigh backscattering in a matrix having two dimensions, wherein said recorded time is one of said at least two variables associated with that respective measurement value.

The image and/or video processing algorithm may comprise an algorithm which is configured to denoise the image matrix.

The image or video processing algorithm may comprise an algorithm which is configured to sharpen said the image matrix, increase dynamic range of particular features in said the image matrix, restore blurring effects in said the image matrix, and/or enhance contrast and edges of said the image matrix.

The image or video processing algorithm may comprise at least one of: an algorithm based on Gaussian Filtering, Non Local Means, Discrete Cosine Transform and/or Discrete Wavelets Transform.

The method may further comprise a step of applying a delay to one or more of the plurality of measurement values.

The method may further comprise storing a plurality of measurement values in a memory.

The method may further comprise, retrieving measurement values from a memory, and including the retrieved measurement values in the matrix, before said steps of transforming and processing are performed.

The method may further comprise the steps of,

retrieving stored measurement values from a memory;

arranging the retrieved measurement values in a matrix having at least two dimensions;

transforming each retrieved measurement value in the matrix to a corresponding pixel value on a predefined scale of pixel values;

forming a second image with pixels having said corresponding pixel values, wherein each pixel in the image is positioned at a position in the image corresponding to the position of said measurement value in the matrix;

processing the image using an image processing algorithm so as to reduce noise in the image to provide a second processed image;

transforming each pixel value of pixels in the second processed image to values to provide a plurality of measurement values with reduced noise.

The distributed optical fibre sensor may be a distributed optical fibre sensor, configured to measure at least one of Brillouin scattering, Raman scattering and/or Rayleigh scattering.

The distributed optical fibre sensor may comprise one or more gratings written in an optical fibre of the sensor.

According to a further aspect of the present invention there is provided a distributed optical fibre sensor comprising a processor which is operable to perform steps according to any one of the above-mentioned methods.

In one embodiment of the method of the present invention, there is provided a method comprises the steps of, acquiring plurality of measurement values using a distributed optical fibre sensor; arranging the plurality of measurement values in a matrix having at least two dimensions; mapping each measurement value in the matrix to a corresponding value on a predefined scale of pixel values, to form an image matrix which is representative of an image; processing the image matrix using an image or video processing algorithm so as to reduce noise in the image matrix to provide processed image matrix; mapping each pixel value of the processed image matrix to measurement values, to provide a plurality of measurement values with reduced noise.

The method may further comprise the step of processing the measurement values with reduced noise to determine a characteristic of an optical fibre of the distributed optical fibre sensor.

The method may further comprise the step of processing the measurement values with reduced noise to determine at least one of temperature, pressure and/or strain in an optical fibre of the distributed optical fibre sensor.

The step of mapping may comprise performing linear mapping, non-linear mapping or inverse mapping, to a corresponding value on a predefined scale of pixel values.

The step of mapping each entry of the matrix to a corresponding value on a predefined scale of pixel values to form an image matrix may comprise, mapping each entry of the matrix to a corresponding value on the predefined scale of pixel values, wherein the highest measured value is mapped to the highest value in the predefined scale of pixel values, and the lowest measured value is mapped to the lowest value in the predefined scale of pixel values.

The measured values having values between the highest and lowest measured values may be mapped to corresponding relative pixels values in the predefined scale of pixel values, so as to form an image matrix which comprises pixels values, corresponding to the plurality of measurement values in said matrix, wherein for each of said measured values the corresponding relative pixels value is such that the ratio of that measured value pixel value to the highest measured value acquired in step (a) is equal to the ratio between the corresponding relative pixel value and the highest pixel value on the predefined scale of pixel values.

The predefined scale of pixel values may be a grayscale.

The predefined scale of pixel values may be a scale of color intensities.

The predefined scale of pixel values may be a color scale.

The step of mapping each pixel value of the processed image matrix back to measurement values, may comprise performing linear mapping, non-linear mapping, or inverse mapping, pixel values to measured values.

The step of mapping each pixel value of the processed image matrix back to measurement values, may comprise mapping the highest pixel value in the processed image matrix to the highest measured value acquired in step (a), and mapping the lowest pixel value in the processed image matrix to the lowest measured value acquired in step (a).

The method may comprise the steps of, for each of the pixel values in the processed image matrix which are between the highest and lowest pixel values to a measured values, mapping that pixel value to a corresponding measurement value wherein the corresponding measurement value is such that the ratio of the pixel value to highest pixel value is equal to the ratio of the corresponding measurement value to the highest measured value acquired in step (a).

The step of arranging the plurality of measurement values in a matrix having at least two dimensions may comprise, positioning each of the measurement values in the matrix according to the values of at least two variables associated with that respective measurement value.

The method may further comprise the step of measuring frequency of a backscatter signal and/or distance from a predefined end of the optical fibre of the sensor at which the measurement value was acquired.

The step of arranging the plurality of measurement values in a matrix having at least two dimensions may comprise, positioning each of the measurement values in the matrix according to the values of at least two variables associated with that respective measurement value, and wherein said at least two variables associated with that respective measurement value comprise said measured frequency and distance.

The step of acquiring a plurality of measurement values using a distributed optical fibre sensor may comprise acquiring plurality of Brillouin response values, and the step of arranging the plurality of measurement values in a matrix having at least two dimensions comprises arranging the acquired Brillouin response values in a matrix having two dimensions.

The step of acquiring plurality of Brillouin response values may comprise acquiring plurality of Brillouin gain values and/or acquiring plurality of Brillouin loss values.

The step of acquiring a plurality of measurement values using a distributed optical fibre sensor, may comprise, using a Brillouin distributed optical fibre sensor to acquire the Brillouin response values, at different frequency shifts between the pump signal and backscattered signal, at different positions along an optical fibre of the Brillouin distributed optical fibre sensor; and wherein the step of arranging the plurality of measurement values in a matrix having at least two dimensions comprises arranging the acquired Brillouin response values in a matrix having two dimensions, and wherein the acquired Brillouin responses are positioned in the matrix according the frequency shifts between the pump signal and backscattered signal and distance from a predefined end of the optical fibre of the sensor at which that Brillouin response was measured.

The step of acquiring plurality of measurement values using a distributed optical fibre sensor may comprise acquiring the response of Rayleigh backscattering, and the step of arranging the plurality of measurement values in a matrix having at least two dimensions comprises arranging the acquired response of Rayleigh backscattering, in a matrix having two dimensions.

The step of acquiring the response of Rayleigh backscattering may comprise acquiring the intensity of Rayleigh backscattering.

The method may further comprise the step of recording the time over which all of the plurality of measurement values are acquired.

The method may further comprise the step using said image matrix and the recorded time at which each measurement value is acquired to generate an 3-D image matrix which is representative of a three-dimensional image or video (sequence of 2D images); and wherein the step of processing the image matrix using an image processing algorithm, comprises processing the 3-D image matrix or video using an 3-D image processing algorithm or video processing algorithm.

The recoded time may define one of said at least two at least two variables associated with that respective measurement value.

The step of acquiring plurality of measurement values using a distributed optical fibre sensor may comprise acquiring response of Raman backscattering, and the step of arranging the plurality of measurement values in a matrix having at least two dimensions comprises arranging the acquired response of Raman backscattering in a matrix having two dimensions, wherein said recorded time is one of said at least two variables associated with that respective measurement value.

The image and/or video processing algorithm may comprises an algorithm which is configured to denoise the image matrix. The image or video processing algorithm may comprises an algorithm which is configured to sharpen said the image matrix, increase dynamic range of particular features in said the image matrix, restore blurring effects in said the image matrix, and/or enhance contrast and edges of said the image matrix. The image or video processing algorithm may comprise an algorithm based on Gaussian Filtering, Non Local Means, Discrete Cosine Transform and/or Discrete Wavelets Transform.

The method may further comprise a step of applying a delay to one or more of the plurality of measurement values.

The method may further comprise a step of storing a plurality of measurement values in a memory.

The method may further comprise a steps of, retrieving measurement values from a memory, and including the retrieved measurement values in the matrix, before said steps of mapping and processing are performed.

The method may further comprise a steps of, retrieving stored measurement values from a memory; arranging the retrieved measurement values in a matrix having at least two dimensions; mapping each retrieved measurement value in the matrix to a corresponding value on a predefined scale of pixel values, to form a second image matrix, wherein the second image matrix is an matrix representative of a second image; processing the second image matrix using the image or video processing algorithm to provide a second processed image matrix; mapping each pixel value of the second processed image matrix to measurement values, to provide a plurality of measurement values with reduced noise.

A distributed optical fibre sensor comprising a processor which is operable to perform steps according to any one of the above-mentioned methods.

In one embodiment the method comprises the steps of, retrieving stored measurement values from a memory; arranging the retrieved measurement values in a matrix having at least two dimensions; mapping each retrieved measurement value in the matrix to a corresponding value on a predefined scale of pixel values, to form a second image matrix, wherein the second image matrix is an matrix representative of a second image; processing the second image matrix using the image or video processing algorithm to provide a second processed image matrix; mapping each pixel value of the second processed image matrix to measurement values, to provide a plurality of measurement values with reduced noise.

According to a further aspect of the present invention there is provided a distributed optical fibre sensor comprising a processor which is operable to perform steps according to any one of the above-mentioned methods.

Some of the key aspects of various embodiments of the present invention include: The use of two-dimensional information contained in the measurements obtained by distributed fibre sensors to provide a higher SNR enhancement when compared to traditional unidimensional processing techniques. Image processing takes full advantage of the bi-dimensional nature of the data acquisition process of some kinds of distributed sensors. Image processing can also be used to enhance 1D data measurements, provided that time is used as a second dimension to reconstruct a 2D image to be processed. In this way the embodiment exploits the redundant information contained in sequential 1D measurements obtained by the system. Video processing make use of all advantages of 2D image processing, but also exploits a third dimension that contains the information from sequential measurements obtained by the system. 2D and 3D processing takes advantage of quasi-distributed sensing systems in which discrete sensors are arranged in a 2D or 3D spatial configuration.

In the present invention image and/or video processing techniques may be used to enhance the performance of distributed optical fibre sensors. The invention can be applied to any kind of optical fibre sensor in which the acquired data can be arranged as a two-dimensional matrix or in a data structure with higher-order dimensions. This includes any possible configuration for fibre characterisation, based for instance in reflectometry (e.g. time-domain or frequency-domain reflectometry); for distributed fibre sensing based on, for example, faint long gratings, Brillouin, Raman or Raman scattering (this also includes any combination of them); as well as for arrays of discrete point sensors, for which the measured information can be arranged in a two-dimensional, or higher-order, data structure.

Essentially the acquired data is interpreted as an image (2D or 3D) or a video sequence (depending if the data is arranged in a single or multiples two-dimensional arrays), and then process this flow of data using suitable multi-dimensional processing algorithms to improve the quality of the images. This processing can be implemented considering each measurement as an independent image or using time as an additional dimension, so that the image enhancement process, such as denoising, benefits also from the redundancy present in the sequence of images. In this way, the proposed method can significantly reduce the loss of accuracy and details when compared to 1D techniques (i.e. in comparison with traditional processing methods reported in the state-of-the-art), making this loss imperceptible. As a result of this processing a better sensor performance is achieved.

In particular, image processing techniques can treat each acquired point (corresponding for example to a given scanned frequency-position pair) as a pixel of a noisy image; thus applying for instance an image or video denoising algorithm can enhance the signal-to-noise ratio (SNR) of the measurements and obtain a better sensor precision. Compared to state-of-the-art methods, the sensor enhancement provided by the multi-dimensional processing proposed in this invention (given by image and video denoising) is based on the level of similitude and redundancy contained in the information measured in a distributed fibre sensor. For example, Brillouin and Rayleigh based sensors retrieve the environmental information measuring a resonant peak in the frequency domain (either the Brillouin gain spectrum or the spectral cross-correlation peak of Rayleigh measurements). It should be noted that Rayleigh based sensors can retrieve the environmental information measuring other parameters from other domains besides frequency. This resonance spectrum is measured at each fibre location (being locally shifted in the frequency domain according to local changes of external environmental quantities), and therefore the obtained position-frequency data structure (here considered as a 2D image) contains highly redundant information that can be smartly used to remove noise over the entire 2D data matrix. In the case of sensors offering only a 1D data information, such as sensors based on Raman scattering, a 2D image can be constructed considering time as a second dimension. In this case consecutive 1D data arrays give origin to a 2D data structure that can be enhanced by image denoising. This concept can be extended to process not only the raw measured signals, but also the distributed measurand profile (e.g. temperature or strain) provided by any distributed fibre sensor.

Prior art solutions which use a 1D denoising algorithm in distance, and then, independently applied to the filtered data in the frequency domain, will not benefit from the similitude and redundancy that can be found in a two-dimensional matrix containing the measured data. In contrast the method proposed in this invention has the potential to offer much better denoising capabilities than state-of-the-art techniques. It should be understood that in the present invention any suitable techniques for image enhancement can be used (different from denoising) to increase the SNR of the measurements of a distributed fibre sensor; this can be obtained using dedicated algorithms, for instance, to sharpen image details, increase the dynamic range of particular features, restore blurring effects, enhance contrast and edges, and several other approaches. Many of those methods actually offer the possibility to recognize objects, or detect special features in an image; this can be very helpful to enhance the quality of the measurand (such as temperature or strain) profiles resulting from distributed fibre sensors.

In this invention the use of 3D image and video processing is also proposed. This can be regarded as a three-dimensional processing, in which each two-dimensional frame is considered as an image that is processed based not only on the redundancy found in the two-dimensional domain but also on the temporal information contained in consecutive measurements. This way, 3D image processing as well as video processing can make use of the high level of correlation existing between consecutive measurements in a distributed fibre sensor; thus offering a higher SNR enhancement to the measurements. Clear examples of this case are distributed fibre sensors based on Brillouin or Rayleigh scattering, in which consecutive 2D data (in distance and frequency) can be combined with time to generate a 3D image or a video (sequence of 2D images).

In another embodiment when time is considered in the processing, either for 2D image processing of 1D measured data or for 3D processing of 2D measured data, three different approaches can be followed:

In the case of real-time measurements, the implementation can only process the information historically contained in previous measurements, thus providing enhanced information of the current environmental conditions.

The invention can be also use to analyse recorded historical measurements of interest, for example for post-analysis of critical events occurred in the past. For this, old information (stored in the system) can be analysed so that the processing can take into account not only the information preceding the event but also the information contained in the future evolution (likely to be highly correlated) after the event.

A third approach can be the use of image or video processing with some short delay with respect to real-time measurements. For example, the method can be used to detect small environmental changes occurred a few minutes (or seconds) before the real-time data acquisition. In this case the processing can take advantage of previous and future information in a small temporal window. Processing data with a short delay can be of great help in the identification of future events, in real-time applications. Certainly this delayed processing can also be combined with real-time processing for a smart prediction of future events.

It is also important to mention that the invention can be used not only for quasi-static measurements, as provided by standard distributed sensing configurations, but also for dynamic real-time sensing. In this case fast and dedicated algorithms must be used. An important feature in video enhancing techniques is related to the trajectory estimation of pixels and motion compensation that can be used, for example, for enhanced video denoising possibilities.

The invention can also be extended to quasi-distributed sensing systems in which several discrete point sensors are used. Actually if discrete sensors are arranged in a 2D or 3D spatial configuration, for example to monitor the strain of an entire civil structure, the set of sensors will provide a 3D map of the strain in the structure. The measured data from these multiple sensors can be processed, for example, by a 3D image (or video) algorithm. The same concept can be applied for a 2D arrangement of point sensors.

The benefits of some embodiments of the present invention include: The method uses the redundancy of the two-dimensional information existing in the data measured by distributed fibre sensors based on faint long gratings, as well as on Brillouin or Rayleigh scattering, thus offering a higher SNR enhancement compared to known and traditionally-used methods. Video processing benefits from two-dimensional information contained in the measurement, but also makes use of the additional level of correlation with the information previously obtained by the system. This enhances the robustness of the data processing, providing even better SNR enhancement to the measurements. The technique can be used to enhance 1D data, provided that time is used as a second dimension to create a two-dimensional data structure forming a noisy image to be processed. This concept includes not only processing the raw measured signals, but can also be used for processing the distributed temperature or strain profiles obtained by any kind of sensor. 2D and 3D processing can also be applied to quasi-distributed systems making use of discrete point sensors arranged in a 2D or 3D configuration. In this way the invention provides a solution for point sensors currently being used, for example, in structural health monitoring. There is no (or negligible) reduction of the spatial resolution and of the accuracy on the measurand quality. The invention can be combined with others techniques, as an additional processing layer, to obtain even better SNR improvement. Simple implementation since no additional expensive hardware is required.

### BRIEF DESCRIPTION OF THE DRAWINGS

The invention will be better understood with the aid of the description of an embodiment given by way of example and illustrated by the figures, in which:

FIG. 1a is a graph illustrating the Brillouin gain response (‘SBS gain’ axis) measured at different pump-probe frequency offsets (‘Frequency’ axis), and measured at different points along the length of the sensing fibre (‘Distance’ axis).

FIG. 1b is a visual representation of a noisy image formed using the measurements illustrated in FIG. 1a;

FIG. 1c is a visual representation of a denoised image;

FIG. 2 shows the 2D data contained in a typical matrix M_{Xcorr}(z, Δf), showing the cross-correlation spectrum obtained as a function of the fibre location after correlating the local measured spectra (i.e. at each fibre location) contained in the matrices Mᵣ(z, f) and Mₜ(z, f);

FIG. 3a is a graph illustrating a typical OTDR trace of the Raman anti-Stokes backscattered along a sensing fibre;

FIG. 3b illustrate the two 2D matrices M_{aS}(z, Tᵢ) and M_{S}(z, Tᵢ); the entries in each row of the 2D matrix M_{aS}(z, Tᵢ ) are independent measurements of the Raman anti-Stokes trace as a function of distance; the entries in each row of the 2D matrix M_{S}(z, Tᵢ) are independent measurements of Stokes trace as a function of distance;

FIG. 4 shows a distributed profile of the temperature (1D array) retrieved by a distributed fibre sensor;

FIG. 5 is a visual representation of multiple distributed measurand (e.g. temperature) profiles acquired at sequential time Tᵢ combined into an image for subsequent processing.

### DETAILED DESCRIPTION OF POSSIBLE EMBODIMENTS OF THE INVENTION

According to the preferred embodiment of the present invention there is provided a method of distributed sensing preferably comprising the steps of:

1. Collecting measurement data (e.g. Brillouin, Rayleigh and Raman measurements from a Brillouin, Rayleigh and Raman sensor)

2. Forming numerical multidimensional matrix (M) (e.g. a 2D Matrix or 3D Matrix) which has the measurement data acquired in step 1 as entries in the multidimensional matrix.

3. Transforming each of the entries in the numerical multidimensional matrix (M) into a respective pixel value (an intensity value (for a pixel of a monochromatic image); a color value; and/or grey value), so as to form an image with pixels having those pixel values.

4. Image processing the image formed in step 3 so as to remove noise from the image (e.g. to smooth-out and/or blend the pixels across the image)

5. Obtaining the pixel value of each pixel in the processed image.

6. Transforming each pixel value obtained in step 5 back into a value having the same units as the measurement data collected in step 1; the values resulting from this transformation are equivalent to the collected measurement data with reduced noise.

7. Preferably the method further comprises determining temperature and/or strain from the values obtained in step 6.

In the present invention image and/or video processing is proposed to reduce noise from measurements taken by distributed fibre sensors, including Brillouin, Rayleigh and Raman based distributed fibre sensors. Each measurement taken by a Rayleigh or Brillouin or Raman sensor will contain noise; each measurement taken by a Brillouin sensor will be in the form of a percentage (Brillouin gain expressed in percent), voltage (as measured on a photodiode), or other suitable arbitrary scale; each measurement taken by a Rayleigh sensor will be in the form of amplitude, a voltage or other suitable arbitrary scale and each measurement taken by a Raman sensors will be in the form of amplitude, a voltage or other suitable arbitrary scale. Each of the measurements taken by a Rayleigh or Brillouin or Raman sensor, are transformed into a pixel value; the pixel value may be a value which represents a pixel color, and/or which represents a color intensity, and/or which represents a grey value. For each measurement the pixel value to which that measurement is transformed will depend on (e.g. will be proportional to) the value/amplitude of that measurement. For example a high measurement will be transformed to a higher color intensity than a low measurement. Each of the pixel values are then used to form a corresponding pixel having that pixel value. The pixels formed collectively define an image (such as a monochromatic image). The image may be a 2-D or 3-D image. Thus the resulting image will contain pixels wherein each pixel of the image corresponds to a measurement taken by a Rayleigh or Brillouin or Raman sensor.

Image processing (e.g. 2D or 3D image processing) is then applied to the image which smooths-out or blends the pixels across the images. By smoothing-out or blending the pixels across the image this has the effect of removing noise from the measurement value which corresponds to that pixel. In one embodiment each of the pixel values are then used to form a corresponding pixel having that pixel value and they are arranged to form a 2D image; in this embodiment invention 2D image processing is applied to the image. In a further embodiment each of the pixel values are then used to form a corresponding pixel having that pixel value and they are arranged to form a 3D image; in this embodiment invention 3D image processing is applied to the image.

After the image processing (e.g. 2D or 3D image processing) has been applied to the image, the pixel value of each pixel in the image is then determined.

Preferably the pixel value of each pixel is then transformed back to a value which has the same form as the original measurements. So for example if the original measurement was a “percentage” (e.g. percentage Brillouin gain) measured by a Brillouin sensor then the pixel value of each pixel is transformed back to a “percentage” value; if the original measurement was a “voltage” (e.g. voltage across a photodiode of a Brillouin sensor representing Brillouin gain) measured by a Brillouin sensor then the pixel value of each pixel is transformed back to a “voltage” value. The resulting values are the original measurements with reduced noise (i.e. the resulting values are a denoised version of the measurement values), which can be further processed according to the methods known in the art. For example, the denoised Brillouin gain is processed such as to identify the peak gain frequency which is subsequently transformed in temperature or strain value.

The image processing of the image serves to reduce the noise that was present in the original measurements which were taken by the Brillouin, or Rayleigh, or Raman sensor. Therefore the values which result from when the pixels of the processed image are transformed back to values which has the same form as the original measurements, will be equivalent to the original measurements with reduced noise. In this manner the present achieves an improved signal-to-noise ratio for measurements taken by distributed fibre sensors.

It should be understood that the present invention can be used to reduce noise in measurements taken by any kind of optical fibre sensor in which the measurements can be arranged as a two-dimensional matrix or in a data structure with higher-order dimensions. This includes any possible configuration for fibre characterisation, based for instance in reflectometry (e.g. time-domain or frequency-domain reflectometry); for distributed fibre sensing based on, for example, faint long gratings, Brillouin, Rayleigh or Raman scattering (this also includes any combination of them); as well as for arrays of discrete point sensors, for which the measured information can be arranged in a two-dimensional, or higher-order, data structure. For example the invention can be used to reduce noise in measurements obtained by BOTDA sensors, in Brillouin optical time-domain reflectometers (BOTDR) or phase-sensitive OTDRs. The present invention can also be used to reduce noise in measurements taken by distributed fibre sensors based on distributed birefringence measurements along an optical fibre; for instance sensing based on dynamic Brillouin grating and phase-sensitive OTDRs, in which the nature of the measured data is bi-dimensional.

In the present invention each measurements taken by the distributed fibre sensor, are transformed into a pixel value (e.g. a value which represents a color, or a value which represents the intensity of a color in a monochromatic image); the pixel values are proportional to the measurement (e.g. proportional to the amplitude of the measurement). These pixel values are then used to define respective pixels of an image, thus each measurement value gives rise to a corresponding pixel of the image. When the measurement taken by the distributed fibre sensor is transformed into a pixel value these pixel values may be used to form pixels of a 2D image or a 3D image or may be a video sequence.

The image processing can be implemented considering each measurement as an independent image, or, using time as an additional dimension, so that the image processing benefits also from the redundancy present in the sequence of images.

The improved signal-to-noise ratio (SNR) achieved by the image processing (e.g. multi-dimensional processing such as 2D image processing or 3D image processing) is based on the level of similitude and redundancy contained in measurements taken by the distributed fibre sensor. For example, Brillouin and some Rayleigh based sensors retrieve the environmental information measuring a resonant peak in the frequency domain (either the Brillouin gain spectrum or the spectral cross-correlation peak of Rayleigh measurements). This resonance spectrum is obtained at each fibre location at different frequency offsets (i.e. being locally shifted in the frequency domain according to local changes of external environmental quantities); the measured amplitude of this spectral resonance is used to build a 2D matrix, whereby each measured amplitude is positioned in the 2D matrix according to the frequency offset and position along the fibre at which that amplitude was measured; each measurement of amplitude of this spectral resonance in this 2D matrix is then transformed to a respective pixel value (such as a value representing a pixel color; and/or a value representing a pixel intensity (for a monochromatic image), and/or a grey value). These pixel values define an image (a “noisy image”); the position of each pixel in the 2D image corresponds to the position of the corresponding measurement in the 2D matrix. In other words each measurement of the sensor in the 2D matrix is transformed to a pixel value; thus after all of the measurements in the 2D matrix are transformed the pixel values will collectively define an image (it should be understood that in this example the image is in the form of a matrix having pixel values as entries in the matrix). The 2D image will contain highly redundant information that can be used to remove noise over the entire 2D data matrix.

As mentioned, the present invention can be used to reduce noise in measurements taken by any distributed fibre sensor. The use of the present invention to reduce the noise in measurements taken by Brillouin, Rayleigh and Raman distributed fibre sensors will now be described by way of example only:

### Brillouin Distributed Fibre Sensing

### 1. Collecting Measurement Data

In Brillouin distributed fibre sensors the measurand information (e.g. temperature and/or strain) is obtained from the spectral response of the Brillouin scattering generated in a sensing fibre. To measure this spectral response, techniques based on time, frequency or correlation domain can be used.

The most common approach is based on time-domain measurements using a pump-probe interaction (i.e. Brillouin optical time-domain analysis (BOTDA)). In Brillouin optical time-domain analysis (BOTDA), the Brillouin gain (amplitude) response is measured by launching into the sensing fibre an optical pulse (i.e. a pump pulse); a counter-propagating continuous-wave optical signal (i.e. a probe signal) is provided in the sensing fibre at different optical frequencies. Optical power is transferred from the pump pulse to the probe signal, generating an amplified probe signal that is measured by the sensor.

Then amplitude of the amplified probe signal is measured (i.e. the Brillouin gain response) for different pump-probe frequency offsets at different points along the length of the sensing fibre. It is pointed out that the measured amplitude of the amplified probe at each point along the sensing fibre is the Brillouin gain response of the sensing fibre at that point.

It is pointed out that in this particular example the Brillouin distributed fibre sensor measures the Brillouin gain response of the sensing fibre at points along the sensing fibre, and each Brillouin gain response value is represented as a “percentage” value.

The measured Brillouin gain responses, the pump-probe frequency offsets, and the positions of the points along the length of the sensing fibre at which the Brillouin gain responses are measured, are all recorded; and this information may be used to characterise the Brillouin gain response of the sensing fibre as a function of frequency, at each longitudinal position along the fibre.

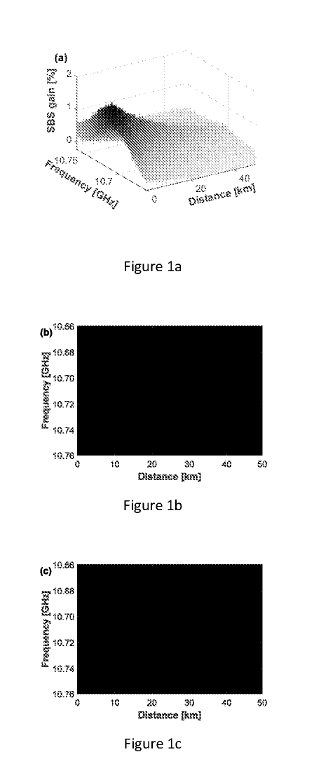

FIG. 1a is a graph illustrating the Brillouin gain response (‘SBS gain’ axis) measured at different pump-probe frequency offsets (‘Frequency’ axis), and measured at different points along the length of the sensing fibre (‘Distance’ axis).

### 2. Forming 2D Matrix M(z, Δf)

The Brillouin gain response measurements made by the Brillouin distributed fibre sensor are used to build a 2D matrix M(z, Δf)

In order to build a 2D matrix M(z, Δf) the 2D matrix M(z, Δf) is positioned in a reference frame which has an x and y axis; each pump-probe frequency offset value is positioned along the y-axis (‘Frequency’ axis), and each position along the fibre where the Brillouin gain response was measured is positioned along the x-axis; the 2D matrix M(z, Δf) is then populated with the measurements (i.e. percentage values) of the Brillouin gain responses (i.e. the measured amplitudes of the amplified probe signal), wherein each Brillouin gain response is positioned in the 2D matrix M(z, Δf) at the x-y position in the matrix which is corresponding to the frequency offset and position at which that Brillouin gain response was measured. Thus each row of the matrix M contains Brillouin gain response entries which were measured at the same pump-probe frequency offset Δf but at different positions along the length of the sensing fibre; while each column contains the Brillouin gain responses which were measured at the same position z along the sensing fibre but at different frequency offsets Δf.

It should be noted that the Brillouin gain response values contained in the 2D matrix M(z, Δf) could alternatively be obtained by other Brillouin sensing schemes existing in the state-of-the-art, for instance using methods based on frequency or correlation domains, or Brillouin reflectometry techniques, instead of Brillouin time-domain analysis as here described. In all these cases the measured data contained in the measured matrix M has equivalent information.

3. Transforming 2D Matrix M(z, Δf) into an Image

Next the 2D matrix M(z, Δf) which contains the Brillouin gain response values as entries, is then converted into a 2D image as shown in FIG. 1b. It should be understood that FIG. 1b is simply a visual illustration of the 2D image (i.e. a visual image having pixels of a particular color/shade/color); it should be understood that the image in practice will preferably be a mathematical matrix having entries which represent pixels of that image. It should be understood that it is not an essential features of the present invention to form a visual representation of the image as shown in FIG. 1b.

The numerical Brillouin gain response entries in the 2D matrix M(z, Δf) are each transformed into a pixel values (such value representing a pixel color corresponding to the intensity associated to a monochromatic color scale; and/or a value representing a pixel intensity, and/or a grey value). An image, a visual representation of which is shown in FIG. 1b, is then formed with pixels having these pixel values.

In order to transform a Brillouin gain response value into a pixel value (e.g. into a color intensity of a monochromatic image (i.e. the monochromatic image has pixels each having single color but the intensity of the color of each pixel being proportional to the Brillouin gain response value), and/or a color, or a grey scale value) the Brillouin gain response value is transformed using, for instance, a linear function that converts Brillouin gain response values in the 2-D matrix into the pixel value. The linear function may take the following format:
Pixel value=((value from 2-D Matrix which is to be transformed)/Highest value in 2-D Matrix))*highest value in pixel value scale
For example the linear function could be :
Color intensity value=((Brillouin gain response value)/Highest Brillouin gain response value in 2-D Matrix))*highest value in color intensity scale)
may be used to convert Brillouin gain response values in the 2-D Matrix into the pixel value in the form of a color intensity value (of a monochromatic image).

For example, a color intensity scale may have values 0-255 each number in the range representing a different color intensity of a single predefined color. In this example in order to transform a Brillouin gain response value to a pixel value a linear function which is configured to transform the Brillouin gain response value into an integer number in the range between 0 and 255 is used; each Brillouin gain value in the 2D-matrix is divided by the highest Brillouin gain value of the 2D-matrix and then multiply by 255 (i.e. the highest value on the pixel value scale (which in this example is color intensity scale 0-255)). The mapping could however also be performed by transforming the Brillouin gain values into a scale of real numbers within a predefined color intensity range.

It should be understood that the pixel value scale is predefined; so for the above examples the color intensity scale (0-255) or the color scale (0-255) is predefined. The scales may be defined by a user or may be standardized pixel scales.

In another example the pixel value into which each Brillouin gain response value is transformed may be a color value. A color scale may have 256 different color intensities each color on the scale being represented by a different number 0-255 (any number 0-255 is considered to define a pixel value which represents a color intensity). In this example in order to transform a Brillouin gain response value to a pixel color value each Brillouin gain value in the 2D-matrix is divided by the highest Brillouin gain value of the 2D-matrix and then multiply by 255 (i.e. the highest value on the pixel value scale (which in this example is color intensity scale 0-255).

An image is then formed using the pixel values. In other words, each Brillouin gain response value in the 2D matrix M(z, Δf) is transformed to a pixel value, and those resulting pixel values define an image (i.e. a matrix having entries in the form of pixel values); each pixel value is positioned at a position in an image corresponding to the position of said Brillouin gain response value in the 2D matrix M(z, Δf). Thus, in this example collectively the pixels form a 2-D image, and each pixel of that 2-D image corresponds to a Brillouin gain response value measured at a particular frequency offset at a particular position along the sensing fibre. It will be understood that in another embodiment a 3-D image could be formed.

The appearance of each pixel in the image is proportional to the numerical value of the Brillouin gain response value which was located at that position. Thus as shown in FIG. 1b the Brillouin gain response entries in the 2D matrix M(z, Δf) with a higher value result in corresponding pixels which appear darker in the visual representation of the image shown in FIG. 1b, than the pixels resulting from Brillouin gain response entries in the 2D matrix with lower values.

The measured Brillouin gain responses will contain noise. Since the pixels of the image have been formed using pixel values derived by transforming those noisy Brillouin gain response values the image formed at this stage is said to be a “noisy image”.

The values of each pixel in the image f(x, y) shown in FIG. 1b belong to a unidimensional space for a monochromatic image. In a variation of this embodiment the 2D matrix M(z, Δf) is converted into an coloured image; in such a case the numerical amplitude of the backscattered signal entries in the 2D matrix M(z, Δf) are transformed into colour values; in the resulting coloured image the values of each pixel in the image f (x, y) belong to a three-dimensional space (a, b, c) for a color image, where the components a, b and c depend on the selection of the color space (such as RGB, HSV, CIE Lab). In this case the elements of the matrix M are represented by scalar numbers, like in a grayscale image, i.e. M contains unidimensional values transforming the measured local Brillouin gain at a given offset Δf and at each fibre position z.

### 4. Image Processing

After the noisy image has been formed by transforming the Brillouin gain response values in the 2D matrix M(z, Δf) into pixel values, and then forming an image with pixel having those pixel values, an image processing technique is applied to noisy image in order to reduce noise in the image (i.e. to smooth-out or blend the pixels of the noisy image) provide a “denoised image” as shown in FIG. 1c.

After the image processing has been applied to the noisy image, the pixels of the resulting image have pixel values which can be transformed back to Brillouin gain response values and these Brillouin gain response values are equivalent to the originally measured Brillouin gain response values with reduced noise. Thus in this application the image which results after the image processing has been applied to the noisy image is referred to as a “denoised image”.

It should be understood that any suitable image processing technique which can remove background noise from an image, can be used in the present invention (i.e. applied to the “noisy image” to provide the “denoised image”). For example image processing techniques which use Gaussian Filtering, Non Local Means, Discrete Wavelets Transform, and/or Discrete Cosine Transform can be used.

Image processing techniques are usually based on the definition of sliding neighbourhoods. The pixel neighbourhood is a subset of the 2D image around the centre pixel (x′, y′) that is being processed. The neighbourhood is usually rectangular (for instance a 3×3 block of pixels centred around (x′, y′)).The centre pixel (x′, y′) is transformed into a filtered pixel (x″, y″) by applying a defined function on the neighbourhood. Examples of such functions are Gaussian Filtering, Non Local Means, Discrete Wavelets Transform, and/or Discrete Cosine Transform.

In image processing technique which use Gaussian Filtering (GF), the value of f(x′, y′) at the centre of a window (neighbourhood) is replaced by a weighted average of f(x, y) inside the window, where the weights are given by a two-dimensional Gaussian function centred at (x′, y′). Gaussian filters are 2D linear filters, and therefore, any increase in the width of the Gaussian function could lead to the unwanted removal of image details.

A more sophisticated version of weighted averages is known as Non Local Means (NLM) algorithm. Similarly to the Gaussian Filtering technique for processing images, the result of NLM is obtained by weighting the values inside a window centred at (x′, y′); however, the weighting factor of a pixel at (x, y) in this case is calculated as the exponential of the Euclidean distance between defined small neighbourhoods around (x′, y′) and (x, y), using an exponential decaying factor that has to be properly adjusted. The optimum decaying factor is defined for example to be proportional to the noise amplitude, which corresponds to the standard deviation on the non-filtered Brillouin gain amplitude. The NLM method can be considered as an improvement respect to Gaussian filters, especially regarding the preservation of edges, texture and fine structures.

Other suitable image processing techniques which can be used in the present invention are image processing techniques using the frequency domain to separate the components of an image associated with high-frequency noise from the components containing relevant information. Within this category, there are algorithms based on the two-dimensional Discrete Cosine Transform (DCT), which converts the values of each sliding window to the frequency domain, then discards the components that are smaller than a certain threshold level and finally converts the result back to the spatial.

Another powerful algorithm for image denoising is the two-dimensional Discrete Wavelets Transform (DWT). This method decomposes an image into subversions containing different levels of detail and applies to each of them a certain threshold method to eliminate noise, so that an image with enhanced SNR is then reconstructed. Preferably several parameters, such as the wavelet basis function, the threshold level, and the number of decomposition levels, are adjusted in a 2D DWT; and hence, all of them have a direct impact on the efficiency of the noise removal.

5. Transforming Each of Pixels in the “Denoised Image” Back into Useful Denoised Numerical Values

Next the pixel values of each of the pixels in the denoised image are obtained. Each of these pixel values are transformed back to Brillouin gain response values. In this example in order to transform the pixel values back into Brillouin gain response values, the inverse of the linear function which was used to transform the Brillouin gain response value into pixel values is used:
Brillouin gain response value=(Highest Brillouin gain response value in original 2-D Matrix)*((Pixel value of pixel in denoised image)/highest value in pixel value scale))
For example the inverse linear function:
Brillouin gain response value=(Highest Brillouin gain response value in original 2-D Matrix)*(Color intensity value of pixel in denoised image/highest value in color intensity scale)
may be used to convert Brillouin gain response values in the original 2-D Matrix into the pixel value in the form of a color intensity value (of a monochromatic image).
Each pixel value in the denoised image is entered into the inverse linear function to determine a corresponding Brillouin gain response value.

The resulting Brillouin gain response values are equivalent to the originally measured Brillouin gain response values with reduced noise. This transformation will result in a matrix M(z, Δf) containing the denoised Brillouin gain values at each pump-probe frequency offset Δg and fibre position z.

Thus by applying the image processing to smooth-out or blend the pixels across the noisy image this has the effect of removing noise from the measured Brillouin gain response values (which were originally transformed to provide the original pixel values for the respective pixels in the noisy image).

### 6. Using the Denoised Brillouin Gain Values to Determine Temperature and Strain etc.

Once the image processing has been applied to the noisy image to provide a denoised image as shown in FIG. 1c and the pixel values of the pixels of the denoised image have been transformed back into numerical Brillouin Gain values (i.e. denoised Brillouin Gain values), then information, such as temperature and strain on the sensing fibre, which is contained in the denoised Brillouin Gain values, can be retrieved by conventional methods.

For example, on each columns of the denoised matrix M(z, Δf) which represent the Brillouin spectrum at position z, a quadratic fit s performed to obtain the spectrum centre frequency fB (also known as Brillouin frequency or Brillouin frequency shift). The result is a linear vector fB(z) with the Brillouin frequency shift along the fibre distance. By applying a calibration coefficient to the Brillouin frequency shift, the corresponding temperature is computed.

### Rayleigh Distributed Fibre Sensing

### 1. Collecting Measurement Data

Rayleigh distributed fibre sensors measure longitudinal variations of the refractive index of the fibre induced by temperature and strain variations. Using a coherent optical source, measurements are based on acquiring the intensity of the Rayleigh backscattered light as a function of the optical frequency used for interrogation. This measurement can be performed in the frequency or time-domain. In the time-domain approach, called optical time-domain reflectometry (OTDR), also referred in this case as coherent-OTDR, a coherent optical pulse, having a given optical frequency, is launched into the sensing fibre, thus generating Rayleigh backscattered light that is acquired as function of the fibre location. Temporal traces are measured using optical pulses with different optical frequencies.

In this embodiment (namely in the time domain approach) the Rayleigh distributed fibre sensors measures coherent Rayleigh amplitude responses (Rayleigh OTDR traces) of the sensing fibre; the coherent Rayleigh amplitude response is measured at different optical frequencies f, and at different positions z along the sensing fibre. The measured coherent Rayleigh amplitude responses (Rayleigh OTDR traces); the optical frequencies f at which each respective coherent Rayleigh amplitude response were measured; and the different positions z along the sensing fibre at which each respective coherent Rayleigh amplitude response were measured, are recorded.

### 2. Forming 2D Matrix Mₜ(z, Δf)

The measured coherent Rayleigh amplitude responses (Rayleigh OTDR traces) are then arranged in a 2D matrix Mₜ(z, f). The entries contained in each row of the 2D matrix Mₜ(z, f) corresponds to the coherent Rayleigh amplitude response measured at a given optical frequency f, while each column contains the coherent Rayleigh amplitude response at each fibre position z.

A reference measurement stored in a matrix Mᵣ(z, f), is then cross-correlated in frequency with the actual Rayleigh measurement stored in a matrix Mₜ(z, f), acquired at a time t. In particular, this spectral cross-correlation is performed at each fibre location z₀, generating a cross-correlation spectrum defined as M_{Xcorr}(z₀, Δf)=Mₜ(z₀, f)*Mᵣ(z₀, f). After performing this spectral cross-correlation at each fibre location a matrix M_{Xcorr}(z, Δf) is obtained. This matrix contains the information of the frequency shift Δf induced in the local Rayleigh reflected spectrum at each fibre location by temperature or strain changes.

Thus in this embodiment (i.e. using a Rayleigh distributed fibre sensor) two matrices are formed, here denoted as Mᵣ and Mₜ, where Mᵣ is used as reference and Mₜ is the real-time measurement obtained at a time t. Before forming an image, these two matrices are spectrally cross-correlated. This means that the cross-correlation of each local spectrum, measured at each fibre location is calculated. This generates a new matrix, referred to here as M_{xcorr}. The values in M_{xcorr} are converted into pixel values and an image is formed with pixel having said pixel values.

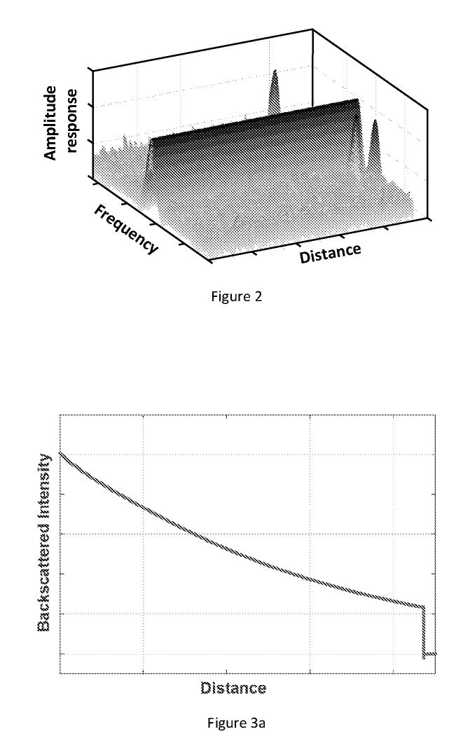

FIG. 2 shows the 2D data contained in a typical matrix M_{Xcorr}(z, Δf), showing the cross-correlation spectrum obtained as a function of the fibre location after correlating the local measured spectra (i.e. at each fibre location) contained in the matrices Mᵣ(z, f) and Mₜ(z, f). As mentioned before, the same matrix M_{Xcorr}(z, Δf) can be obtained performing measurements in the frequency domain, using for instance optical frequency-domain reflectometry (OFDR).

3. Transforming 2D Matrix M_{Xcorr}(z, Δf) into an Image

Each of the spectral cross-correlation numerical entries in the matrix M_{xcorr}(z, Δf) is then transformed into pixel values (such as a pixel intensity (for a pixel of a monochromatic image), a pixel color, or a grey value); and then an image is formed with pixels having said pixel values. In other words, for each spectral cross-correlation value in the 2D matrix M_{Xcorr}(z, Δf) that spectral cross-correlation value is transformed into a pixel value, and then a pixel with that pixel value is positioned at a position in an image corresponding to the position of said spectral cross-correlation value in the 2D matrix M_{Xcorr}(z, Δf).

Preferably the pixel values into which the numerical entries in the matrix M_{Xcorr}(z, Δf) are pixel intensities and the image is a monochromatic image and the pixels of that monochromatic image have intensities corresponding to the pixel intensities provided by transforming corresponding numerical entries in the matrix M_{Xcorr}(z, Δf).

Thus in this preferred embodiment the numerical amplitude of the spectral cross-correlation entries in the 2D matrix M_{Xcorr}(z, Δf) are transformed into values corresponding to the intensity associated to a monochromatic color scale, thus creating an image.

It should be understood that the cross-correlation values could be transformed into a pixel value using the same technique as described in the above-mentioned example relating to Brillouin sensing. For example the same/or similar linear functions could be used to transform each of the cross-correlation values into a pixel value such as a color intensity or a color value, or a grey value. For example to transform cross-correlation values into the color intensity of a monochromatic image, the cross-correlation levels can be mapped using, for instance, a linear function that converts correlations values into a new scale of values defined in the image. For example, the use of an 8-bit image could require a linear conversion of the cross-correlation amplitude into a scale of integer numbers in the range between 0 and 255. The mapping could however also be performed by transforming the cross-correlation levels into a scale of real numbers within a predefined color intensity range. The appearance of each pixel in the image is proportional to the numerical value which was located at that position in the matrix M_{Xcorr}(z, Δf). Thus, as for the example illustrated in FIG. 2, in a visual representation of the image the entries in the matrix M_{Xcorr}(z, Δf) with higher numerical values result in corresponding pixels which appear darker than the pixels resulting from entries in matrix M_{Xcorr}z, Δf) with lower numerical values.

Accordingly, as a result of this transformation each acquired position-frequency pair (z, Δf) stored in the matrix M_{Xcorr}(z, Δf) is transformed into a respective pixel (x, y) of a noisy image, where x and y are the spatial coordinates of the image. The data in the matrix M_{Xcorr}(z, Δf) could be represented by a two-variable function f(x, y) with values belonging to a 1D space, like in a grayscale image, and transforming the local cross-correlation of the coherent Rayleigh amplitude response measured at a given position z and frequency offset Δf.

The measured coherent Rayleigh amplitude responses (Rayleigh OTDR traces) will contain noise. Since the pixels of the image have been formed using pixel values derived by transforming spectral cross-correlation values which were obtained using those noisy coherent Rayleigh amplitude response (Rayleigh OTDR traces) values, the image formed at this stage is said to be a “noisy image”.

### 4. Image Processing

After the noisy image has been formed by transforming each of the spectral cross-correlation values in the matrix M_{Xcorr}(z, Δf) into pixel values, an image processing technique is applied to noisy image in order to reduce noise in the image (i.e. to smooth-out or blend the pixels of the noisy image) provide a “denoised image”.

After the image processing has been applied to the noisy image, the pixels of the resulting image can be transformed back to spectral cross-correlation values. These spectral cross-correlation values are equivalent to the originally obtained spectral cross-correlation values but with reduced noise. Thus in this application the image which results after the image processing has been applied to the noisy image is referred to as a “denoised image”.

It should be understood that any suitable image processing technique which can remove background noise from an image, can be used in the present invention (i.e. applied to the “noisy image” to provide the “denoised image”). For example image processing techniques which use Gaussian Filtering, Non Local Means, Discrete Wavelets Transform, and/or Discrete Cosine Transform can be used.

Image processing techniques are usually based on the definition of sliding neighbourhoods. The pixel neighbourhood is a subset of the 2D image around the centre pixel (x′, y′) that is being processed. The neighbourhood is usually rectangular (for instance a 3×3 block of pixels centred around (x′, y′)). The centre pixel (x′, y′) is transformed into a filtered pixel (x″, y″) by applying a defined function on the neighbourhood. Examples of such functions are Gaussian Filtering, Non Local Means, Discrete Wavelets Transform, and/or Discrete Cosine Transform.

In image processing technique which use Gaussian Filtering (GF), the value of f(x′, y′) at the centre of a window (neighbourhood) is replaced by a weighted average of f(x, y) inside the window, where the weights are given by a two-dimensional Gaussian function centred at (x′, y′). Gaussian filters are 2D linear filters, and therefore, any increase in the width of the Gaussian function could lead to the unwanted removal of image details.

A more sophisticated version of weighted averages is known as Non Local Means (NLM) algorithm. Similarly to the Gaussian Filtering technique for processing images, the result of NLM is obtained by weighting the values inside a window centred at (x′, y′); however, the weighting factor of a pixel at (x, y) in this case is calculated as the exponential of the Euclidean distance between defined small neighbourhoods around (x′, y′) and (x, y), using an exponential decaying factor that has to be properly adjusted. The optimum decaying factor is defined for example to be proportional to the noise amplitude, which corresponds to the standard deviation on the non-filtered cross-correlation spectrum. The NLM method can be considered as an improvement respect to Gaussian filters, especially regarding the preservation of edges, texture and fine structures.

Other suitable image processing techniques which can be used in the present invention are image processing techniques using the frequency domain to separate the components of an image associated with high-frequency noise from the components containing relevant information. Within this category, there are algorithms based on the two-dimensional Discrete Cosine Transform (DCT), which converts the values of each sliding window to the frequency domain, then discards the components that are smaller than a certain threshold level and finally converts the result back to the spatial.

Another powerful algorithm for image denoising is the two-dimensional Discrete Wavelets Transform (DWT). This method decomposes an image into subversions containing different levels of detail and applies to each of them a certain threshold method to eliminate noise, so that an image with enhanced SNR is then reconstructed. Preferably several parameters, such as the wavelet basis function, the threshold level, and the number of decomposition levels, are adjusted in a 2D DWT; and hence, all of them have a direct impact on the efficiency of the noise removal.

5. Transforming Each of Pixels in the “Denoised Image” Back into Useful Denoised Numerical Values

Next the pixel values of each of the pixels in the denoised image are obtained. For example the pixel intensity of each pixel in the denoised monochromatic image is obtained.

Each pixel value in the denoised image is then transformed back into spectral cross-correlation values. This transformation can be performed inverting the function which was previously used to convert the spectral cross-correlation values into a pixel values. For example transformation can be performed inverting the function used to convert the spectral cross-correlation values into color intensity values, and then applying the inverse function to each of the pixel values of the pixels in the denoised image so as to convert each pixel value back to a spectral cross-correlation value. Each pixel value in the denoised image could be transformed back into spectral cross-correlation values using the same technique as described in the above-mentioned example relating to Brillouin sensing; for example the same/or similar inverse linear functions could be used to transform each pixel value (color intensity, or a color value, or a grey value) in the denoised image back into a spectral cross-correlation value.

The spectral cross-correlation values obtained by converting each of the pixel values of the pixels in the denoised image back to a spectral cross-correlation value, are used for form a matrix M_{Xcorr}(z, Δf); the position of each a spectral cross-correlation value in the matrix M_{Xcorr}(z, Δf) corresponding to the position of the pixel in the denoised image from which the spectral cross-correlation value was determined. Thus the matrix M_{Xcorr}(z, Δf) contains the denoised spectral cross-correlation amplitude at each frequency offset Δf and fibre position z.

### 6. Using the Denoised Numerical Rayleigh Amplitude Response Value to Determine Temperature and Strain etc.

Once the image processing has been applied to the image to provide a denoised image and the pixel values of each of the pixels of the denoised image have been obtained and transformed back into spectral cross-correlation values then information, such as temperature and strain on the sensing fibre, which is contained in the spectral cross-correlation values, can be retrieved by conventional methods.

These conventional methods include, for example, fitting a quadratic curve to the cross-correlation spectrum at each fibre position in order to find the frequency corresponding to the maximum cross-correlation amplitude. This peak frequency contains the temperature and strain variations in the fibre. As a result of this process, a distributed profile of the temperature and strain along the fibre is obtained by converting variations of the cross-correlation peak frequency into strain and temperature changes. This is calculated based on the Rayleigh frequency sensitivity on temperature and strain. For example, a conventional single-mode fibre shows a temperature sensitivity of about 1.5 GHz/K and a strain sensitivity of about 150 MHz/με. Knowing those values, changes of correlation peak frequency can be converted into temperature and/or strain changes.

### Raman Distributed Fibre Sensing

In the case of distributed fibre sensors offering only a 1D data information, such as Raman based distributed fibre sensors, a 2D image can be constructed by using time as a second dimension. In this case consecutive 1D data arrays give origin to a 2D matrix which can be transformed into an image to which image processing can be applied so as reduce noise in the image and ultimately thus reduce noise in the measurements taken by the Raman sensor.

### 1. Collecting Measurement Data

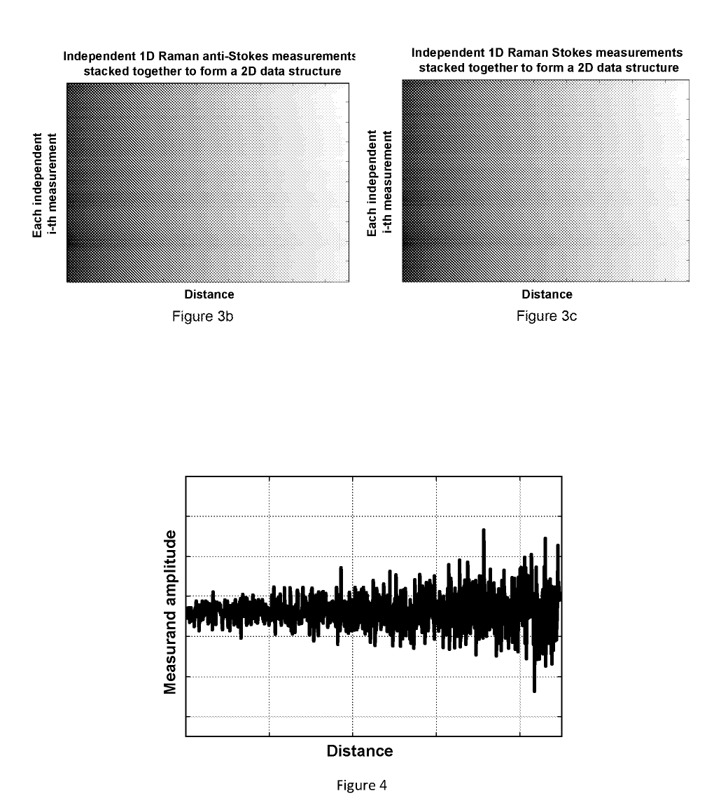

The working principle of Raman distributed optical fibre sensors is based on the temperature dependence of the intensity of the spontaneous Raman anti-Stokes backscattering process. In order to obtain the variations of this backscattered spontaneous Raman scattering light along a sensing fibre, an optical time-domain reflectometry (OTDR) technique is typically employed. The method comprises launching short optical pulses into the sensing fibre and detecting the backscattered spontaneous Raman signal with a temporal resolution given by the pulse duration and receiver bandwidth. The amplitude of this temporal Raman trace contains information of the local temperature along the sensing fibre. FIG. 3a shows a typical OTDR trace of the Raman anti-Stokes backscattered along the fibre.

To retrieve the temperature information, this trace is normalized by another temperature-independent OTDR trace, such as the Raman Stokes or the Rayleigh backscattered light originated from the launched optical pulse. Raman Stokes and Rayleigh OTDR traces also have similar shape as the trace shown in FIG. 3a, but being temperature independent.

In the present invention measured traces are stored in two unidimensional (1D) arrays, one array containing the amplitude of the anti-Stokes signal and another array containing the amplitude of either the Raman Stokes or Rayleigh signal. Calculations using these two 1D data arrays give rise to another 1D array containing the temperature profile of the fibre as a function of the fibre location. This process is repeated indefinitely during operation of the sensor, originating consecutive and independent 1D arrays containing the distributed temperature profile evolving in time at different consecutive moments of acquisition.

### 2. Forming Matrices MₐS and MS

In contrast to examples described above with respect to the Brillouin and Rayleigh distributed sensors where the measured data is two-dimensional, in this embodiment a 2D matrix is generated from 1D Raman traces: Two 2D data structures, matrices M_{aS}(z, Tᵢ) and M_{S}(z, Tᵢ ) (one for the anti-Stokes and another for the Stokes- or Rayleigh-component), are formed in the distance-time (z, Tᵢ) domain by stacking consecutive 1D traces obtained from sequential measurements, Tᵢ designating the moment of the acquisition of the i^{th} trace. FIG. 3b illustrate the two 2D matrices M_{aS}(z, Tᵢ) and M_{S}(z, Tᵢ). The entries in each row of the 2D matrix M_{aS}(z,Tᵢ) are independent measurements of the Raman anti-Stokes trace as a function of distance. The entries in each row of the 2D matrix M_{S}(z, Tᵢ) are independent measurements of Stokes trace as a function of distance.

3. Transforming Matrices M_{aS} and M_{S} into an Image

The two 2D matrices M_{aS}(z, Tᵢ) and M_{S}(z, Tᵢ) are then transformed into respective images so as to provide two noisy images; one noisy image formed by transforming matrix M_{aS}(z, Tᵢ) and a second noisy image formed by transforming matrix M_{S}(z, Tᵢ). The numerical value of the intensities of the spontaneous Raman scattering entries in the 2D matrix M_{aS}(z, Tᵢ) and M_{S}(z, Tᵢ) are transformed into values corresponding to the intensity associated to a monochromatic color scale, thus creating two images a visual representation of which is shown in FIG. 3b. FIG. 3b illustrates a visual representation of the two noisy images which are formed when the respective two 2D matrices M_{aS}(z, Tᵢ) and M_{S}(z, Tᵢ) are transformed. To transform spontaneous Raman intensity values into the color intensity of a monochromatic image, spontaneous Raman intensity levels can be mapped using, for instance, a linear function that converts Raman intensity values into a new scale of values defined in the images. For example, the use of 8-bit images could require a linear conversion of the spontaneous Raman intensity into a scale of integer numbers in the range between 0 and 255. The mapping could however also be performed transforming spontaneous Raman intensity levels into a scale of real numbers within a predefined color intensity range.

The appearance of each pixel in the respective noisy images is proportional to the numerical value which was located at that position in the matrices M_{aS}(z, Tᵢ) and M_{S}(z, Tᵢ). Thus as shown in FIG. 3b the entries in the matrices M_{aS}(z, Tᵢ) a with higher numerical values (i.e. higher Raman anti-Stokes values) result in corresponding pixels which appear darker than the pixels resulting from entries in the matrices M_{aS}(z, Tᵢ) with lower numerical values (i.e. lower Raman anti-Stokes values); while entries in the matrices M_{S}(z, Tᵢ) a with higher numerical values (i.e. higher Raman Stokes values) result in corresponding pixels which appear darker than the pixels resulting from entries in the matrices M_{S}(z, Tᵢ) with lower numerical values (i.e. lower Raman Stokes values).

### 4. Image Processing

An image processing technique, to remove noise, is then applied to each of the two noisy images independently, and provide two respective denoised images.

It should be understood that any suitable image processing technique which can remove background noise from an image, can be used in the present invention (i.e. applied to the “noisy image” to provide the “denoised image”). For example image processing techniques which use Gaussian Filtering, Non Local Means, Discrete Wavelets Transform, and/or Discrete Cosine Transform can be used.

Image processing techniques are usually based on the definition of sliding neighbourhoods. The pixel neighbourhood is a subset of the 2D image around the centre pixel (x′, y′) that is being processed. The neighbourhood is usually rectangular (for instance a 3×3 block of pixels centred around (x′, y′)). The centre pixel (x′, y′) is transformed into a filtered pixel (x″, y″) by applying a defined function on the neighbourhood. Examples of such functions are Gaussian Filtering, Non Local Means, Discrete Wavelets Transform, and/or Discrete Cosine Transform.

In image processing technique which use Gaussian Filtering (GF), the value of f(x′, y′) at the centre of a window (neighbourhood) is replaced by a weighted average of f(x, y) inside the window, where the weights are given by a two-dimensional Gaussian function centred at (x′, y′). Gaussian filters are 2D linear filters, and therefore, any increase in the width of the Gaussian function could lead to the unwanted removal of image details.

A more sophisticated version of weighted averages is known as Non Local Means (NLM) algorithm. Similarly to the Gaussian Filtering technique for processing images, the result of NLM is obtained by weighting the values inside a window centred at (x′, y′); however, the weighting factor of a pixel at (x, y) in this case is calculated as the exponential of the Euclidean distance between defined small neighbourhoods around (x′, y′) and (x, y), using an exponential decaying factor that has to be properly adjusted. The optimum decaying factor is defined for example to be proportional to the noise amplitude, which corresponds to the standard deviation on the non-filtered Raman anti-Stokes or Stokes trace amplitude. The NLM method can be considered as an improvement respect to Gaussian filters, especially regarding the preservation of edges, texture and fine structures.

Other suitable image processing techniques which can be used in the present invention are image processing techniques using the frequency domain to separate the components of an image associated with high-frequency noise from the components containing relevant information. Within this category, there are algorithms based on the two-dimensional Discrete Cosine Transform (DCT), which converts the values of each sliding window to the frequency domain, then discards the components that are smaller than a certain threshold level and finally converts the result back to the spatial.

Another powerful algorithm for image denoising is the two-dimensional Discrete Wavelets Transform (DWT). This method decomposes an image into subversions containing different levels of detail and applies to each of them a certain threshold method to eliminate noise, so that an image with enhanced SNR is then reconstructed. Preferably several parameters, such as the wavelet basis function, the threshold level, and the number of decomposition levels, are adjusted in a 2D DWT; and hence, all of them have a direct impact on the efficiency of the noise removal.

It should be noted that the principle of Raman distributed sensing is to measure quasi-static temperature changes, in which the measurand (i.e. the temperature) slowly changes when compared to the acquisition time, and therefore consecutive traces are typically highly correlated. Image processing here exploits this high degree of similitude and redundancy (in the time and distance domains) existing in Raman distributed measurements. This higher level of redundancy allows discriminating useful information from noise, enabling a good elimination of the noisy randomly-varying components (noise) affecting the measurements.

5. Transforming Each of Pixels in the “Denoised Image” Back into Useful Denoised Numerical Values

The value of each pixel, associated to the intensity of monochromatic color of the two images, can be transformed back into values of the spontaneous Raman anti-Stokes and Stokes intensities. This transformation can be performed inverting the function used to convert the spontaneous Raman intensity values into color intensity in the images. This process generates two new matrices M_{aS}(z, Tᵢ) and M_{S}(z, Tᵢ), containing the denoised version of the spontaneous Raman intensity values at an acquisition time Tᵢ and fibre position z.

### 6. Using the Denoised Numerical Raman Stokes Values and Raman Anti-Stokes Values to Determine Temperature.

In order to retrieve the temperature profile along the fibre corresponding to a measurement time Tᵢ, the denoised Raman anti-Stokes trace contained in M_{aS}(z, Tᵢ) and corresponding to a measurement time Tᵢ is divided by the denoised Raman Stokes trace contained in M_{S}(z, Tᵢ) and corresponding to a measurement time Tᵢ. This ratio between anti-Stokes and Stokes traces depends on temperature. In general a linear temperature dependence of this ratio is considered in practical systems. In order to obtain temperature changes from changes in the anti-Stokes to Stokes ratio, a calibration procedure is performed, in which the temperature sensitivity of this ratio is determined. Using this calibration, variations of the anti-Stokes to Stokes ratio can be linearly converted into temperature changes. If the sensor is intended to measure a wide temperature range a more precise calibration may be required, in which a non-linear dependence of the ratio on temperature is considered.

The above examples describing the exemplary use of the invention in Brillouin, Rayleigh and Raman applications, show how the present invention can be used to reduce signal to noise ratio in direct measurements taken by the distributed fibre sensor. However, it should be understood that the present invention can also be applied to a distributed measurand profile (e.g. temperature or strain) provided by any distributed fibre sensor. The three kinds of distributed fibre sensors (Brillouin, Rayleigh, and Raman) provide a 1D data array containing the distributed profile of the measurand (e.g. temperature or strain) as a function of distance. FIG. 4 shows a distributed profile of the temperature (1D array) retrieved by a distributed fibre sensor along a fibre at near constant temperature. This kind of trace is repeatedly obtained during operation of the sensor, originating consecutive and independent 1D arrays containing the distributed measurand profile evolving in time at different consecutive moments of acquisition. Contrary to our previously described examples where the image processing is applied to the measured data, and later the temperature and strain profiles are calculated from the denoised data; in this embodiment image processing is applied to the retrieved strain or temperature profiles. Thus in this embodiment standard measurements (e.g. standard Brillouin, Rayleigh and Raman measurement) are taken using processing methods known in the field; and thereafter the image processing is applied to the retrieved temperature strain or temperature profiles. In the preferred embodiment a series of temperature or strain measurements in the time domain are obtained using standard Brillouin, Rayleigh and Raman measurement processing methods known in the field; a matrix is built using said series of temperature or strain measurements; and each of the values in the matrix are transformed into a pixel value to form an image (i.e. a matrix having entries in the form of pixel values); image processing is then applied to the image and the pixel values of the processed image are then transformed back to temperature or strain values which are equivalent to the originally measured temperature or strain measurements with reduced noise.

The invention here described can also be applied to remove noise directly from this kind of 1D array containing the measurand profile. For this, a 2D data matrix M(z, Tᵢ) is generated in the distance-time (z, Tᵢ) domain by stacking consecutive 1D traces of the measurand obtained from sequential measurements, Tᵢ designating the moment in time of the acquisition of the i^{th} trace.

Each of the numerical entries in the matrix M(z, Tᵢ) are then transformed into a monochromatic image. The numerical amplitude of the measurand (i.e. strain, temperature or any other variable) amplitude entries in the 2D matrix M(z, Tᵢ) are transformed into values corresponding to the intensity associated to a monochromatic color scale, thus creating an noisy image. To transform measurand values into the color intensity of a monochromatic image, the measurand levels can be mapped using, for instance, a linear function that converts measurand values into a new scale of values defined in the image. For example, the use of an 8-bit image could require a linear conversion of the cross-correlation amplitude into a scale of integer numbers in the range between 0 and 255. The mapping could however also be performed transforming the measurand levels into a scale of real numbers within a predefined color intensity range.

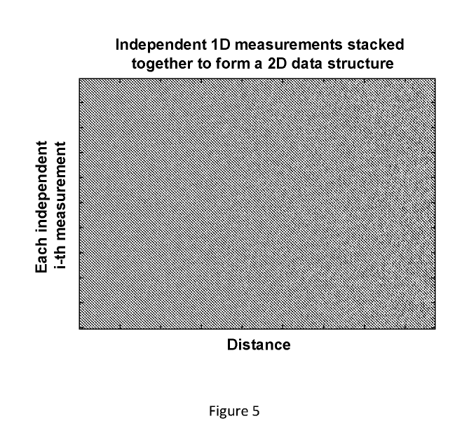

This way each row of the 2D matrix represents an independent measurement of the measurand profile. This 2D data representation is shown in FIG. 5, where darker grey tones represent higher measurand (temperature) amplitude. Then this 2D matrix is processed by image denoising techniques to remove noise from the measurements. Image processing here exploits this high degree of similitude and redundancy (in the time and distance domains) existing in the distributed measurand profile. This higher level of redundancy allows discriminating useful information from noise, enabling a good elimination of the noisy randomly-varying components (noise) affecting the measurements.

In the above-mentioned example embodiments the use of image processing techniques which reduce noise in an image are used. However it should be understood that the present invention is not limited to requiring the use of image denoising (multi-dimensional) processing algorithms to improve the quality of the images; any suitable image processing technique may be applied to the image to increase the signal to noise ratio in measurements which were taken by the distributed fibre sensor. For example image processing techniques which, for instance, sharpen image details, increase the dynamic range of particular features, restore blurring effects, enhance contrast and edges, and several other approaches may be used in the present invention (i.e. may be applied to the image formed using the measurements of the distributed fibre sensor). In one embodiment the present invention applies an image processing technique to the image which recognizes objects, or detects predefined features in an image; such an embodiment can be very helpful to enhance the quality of the measurand (such as temperature or strain) profiles resulting from distributed fibre sensors.

Since the temporal evolution of the measurand variable (such as strain, temperature, pressure, etc.) in a distributed fibre sensor typically varies slowly in comparison to the measurement time, consecutive measurements likely contain highly correlated information. As described before, the use of image processing can be used to enhance the quality of 1D measurements provided by some kinds of sensors, considering time as a second dimension to create an image to be processed. In another embodiment of the present invention, the use of 3D image and video processing is also proposed to achieve an improved SNR. This can be regarded as a three-dimensional processing, in which each two-dimensional frame is considered as an image that is processed based not only on the redundancy found in the two-dimensional domain but also on the temporal information contained in consecutive measurements. This way, 3D image processing as well as video processing can make use of the high level of correlation existing between consecutive measurements in a distributed fibre sensor; thus offering a higher SNR enhancement to the measurements. Clear examples of this case are distributed fibre sensors based on Brillouin or Rayleigh scattering, in which consecutive 2D data (in distance and frequency) can be combined with time to generate a 3D image or a video (sequence of 2D images).

In the present invention the signal value in each measured data point taken by the distributed fibre sensor, is transformed into a value that represents the intensity of a single color in a monochromatic image, where each data point represents a corresponding pixel and the signal value of each data point represent the intensity associated to each pixel in the image; when all the values of the data points have been transformed they may collectively define either a 2D image, a 3D image, or a video sequence. In the above-mentioned embodiments each measurement was transformed so that they collectively define a 2D image; we will now describe exemplary embodiments wherein the measured signal values taken by the distributed fibre sensor are transformed so that they collectively define either a 3D image or a video sequence:

The principle of distributed fibre sensing assumes that the temporal evolution of the measurand changes slowly compared to the acquisition time. In the case of Brillouin and Rayleigh sensors, this leads to consecutive 2D measurements containing highly correlated information. Based on this feature, the concept of 2D image processing can be extended to a 3D processing case, i.e. to the use of video or 3D image processing. In this case the measurement procedure is exactly the same as described before for the Brillouin and Rayleigh distributed sensing techniques. In both cases a 2D matrix—previously denoted as matrices M(z, Δf) and M_{Xcorr}(z, Δf )—is obtained during the measurement, from which the temperature and strain information are retrieved by analysing the peak frequency of the measured Brillouin response (in a Brillouin sensor) or the peak frequency of the calculated cross-correlation Rayleigh response (in a Rayleigh sensor). In the two kind of sensors, the 3D processing here described requires storing the measured data in a 3D data structure (matrix M_{3D}(z, Δf, Tᵢ)), which contains consecutive and independent 2D data, as obtained from each measurement at a time Tᵢ. Each of these measurements (i.e. in the position-frequency domain, as represented in matrices M(z, Δf) and M_{Xcorr}(z, Δf) is assimilated to a frame of a video sequence. Before applying video processing techniques, each of the numerical entries in the matrix M_{3D}(z, Δf, Tᵢ) are transformed into a monochromatic pixel value. The numerical values contained in the matrix M_{3D}(z, Δf, Tᵢ) are transformed into values corresponding to the intensity associated to a monochromatic color scale. To transform Brillouin gain or Rayleigh cross-correlation values into the color intensity of a monochromatic video, the Brillouin gain or Rayleigh cross-correlation levels can be mapped using, for instance, a linear function that converts those values into a new scale of values defined in the video. For example, the use of an 8-bit video could require a linear conversion of the data contained in M_{3D}(z, Δf, Tᵢ) into a scale of integer numbers in the range between 0 and 255. The mapping could however also be performed transforming the values in M_{3D}(z, Δf, Tᵢ) into a scale of real numbers within a predefined color intensity range. This way the video generated from transforming the data in matrix M_{3D}(z, Δf, Tᵢ) containing consecutive 2D measurements M(z, Δf) or M_{Xcorr}(z, Δf) is then processed by a video or 3D image processing method. This approach exploits not only the redundancy found in the two-dimensional domain of the measurements contained in the matrices M(z, Δf) and M_{Xcorr}(z, Δf), but also in the temporal dimension. This means that much more data points, all showing some high level of correlation, can be used simultaneously to reduce noise from the entire set of measurements, thus leading to a very powerful tool for a better noise removal in distributed fibre sensing.

Once the measurement noise has been removed from the video, a matrix M_{3D}(z, Δf, Tᵢ) is obtained after transforming back the pixel values into Brillouin gain values (in a Brillouin sensor) or spectral cross-correlation values (in a Rayleigh sensor). This transformation can be performed inverting the function used to convert the Brillouin gain values or spectral cross-correlation values into color intensity in the images. This process generates a new matrix M(z, Δf) or M_{Xcorr}(z, Δf), containing the denoised Brillouin gain or spectral cross-correlation values at each frequency offset Δf and fibre position z. The obtained matrix represents a denoised version of the 2D data originally contained in matrix M(z, Δf) or M_{Xcorr}(z, Δf) for each independent measurement corresponding to the acquisition Tᵢ. This 2D data is then used to retrieve the distributed temperature and strain profiles along the fibre, following the same conventional methods used in Brillouin and Rayleigh sensing. This involves, for example, fitting a quadratic curve to the local Brillouin spectrum or the local Rayleigh cross-correlation spectrum at each fibre position in order to find the frequency corresponding to the maximum Brillouin or Rayleigh cross-correlation amplitude. This peak frequency contains the temperature and strain variations in the fibre. As a result of this process, a distributed profile of the temperature and strain along the fibre is obtained by converting variations of the Brillouin frequency shift or of the spectral correlation-peak into strain and temperature changes. This is calculated based on the known strain and temperature sensitivities of the Brillouin or Rayleigh scattering.

The embodiments wherein a time variable in included in the matrix which is to be transformed to from the noisy image, then three different approaches can be followed:

In the case of real-time measurements, the implementation can only process the information historically contained in previous measurements, thus providing enhanced information of the current environmental conditions.

The invention can be also use to analyse recorded historical measurements of interest, for example for post-analysis of critical events occurred in the past. For this, old information (stored in the system) can be analysed so that the processing can take into account not only the information preceding the event but also the information contained in the future evolution (likely to be highly correlated) after the event.

A third approach can be the use of image or video processing with some short delay with respect to real-time measurements. For example, the method can be used to detect small environmental changes occurred a few minutes (or seconds) before the real-time data acquisition. In this case the processing can take advantage of previous and future information in a small temporal window. Processing data with a short delay can be of great help in the identification of future events, in real-time applications. Certainly this delayed processing can also be combined with real-time processing for a smart prediction of future events.

It should also be understood that the invention can be used not only for quasi-static measurements, as provided by standard distributed sensing configurations, but also for dynamic real-time sensing. In this case fast and dedicated algorithms are preferably used. An important feature in video enhancing techniques is related to the trajectory estimation of pixels and motion compensation that can be used, for example, for enhanced video denoising possibilities. A possible embodiment to implement dynamic sensing is exactly the same as previously described in Brillouin distributed optical fibre sensing. This means that the same method can be followed to acquire the data, calculate the Brillouin gain and store it in a matrix M(z, Δf). This followed by the same method of forming an image, denoise the image with an image processing method and the same method to convert back the values of the denoised image into Brillouin gain values. Then the same process can be used for retrieving the strain information along the fibre. The only difference with the previously describe procedure—which aims at quasi-static measurements—is that all the process has to be performed in a much shorter time. This could mean that a much lower number of traces could be averaged to speed up the measurement time. A possible optimization consists in using a probe wave signal that consecutively changes its optical frequency during the measurement process, so that a very-long single temporal trace can be measured containing all scanned pump-probe frequency offsets Δf. Then the matrix M(z, Δf) can be generated by splitting this long time-domain trace in order to allocate the Brillouin gain corresponding to each individual pump-probe frequency offset Δf in each row of the matrix M(z, Δf), while each column of the matrix M(z, Δf) contains the Brillouin gain value at a given fibre position z. This matrix is equivalent to the matrix M(z, Δf) obtained from the conventional Brillouin interrogation, and therefore all the rest of the procedure necessary to implement this invention remain as explained before.

The invention can also be extended to quasi-distributed sensing systems in which several discrete point sensors are used. Actually if discrete sensors are arranged in a 2D or 3D spatial configuration, for example to monitor the strain of an entire civil structure, the set of sensors will provide a 3D map of the strain in the structure. The measured data from these multiple sensors can be processed, for example, by a 3D image (or video) algorithm. The same concept can be applied for a 2D arrangement of point sensors.

Various modifications and variations to the described embodiments of the invention will be apparent to those skilled in the art without departing from the scope of the invention as defined in the appended claims. Although the invention has been described in connection with specific preferred embodiments, it should be understood that the invention as claimed should not be unduly limited to such specific embodiment.

What is claimed is:

1. A method of distributed sensing comprising the steps of,
(a) acquiring plurality of measurement values using a distributed optical fibre sensor;
(b) arranging the plurality of measurement values in a matrix having at least two dimensions;
(c) transforming each measurement value in the matrix to a corresponding pixel value on a predefined scale of pixel values to form an image;
(d) processing the image using an image processing algorithm so as to reduce noise in the image to provide a processed image;
(e) transforming each pixel value of pixels in the processed image to provide a plurality of measurement values with reduced noise.

2. A method according to claim 1 further comprising the step of processing the measurement values with reduced noise to determine a characteristic of an optical fibre of the distributed optical fibre sensor.

3. A method according to claim 1 comprising the step of processing the measurement values with reduced noise to determine at least one of temperature, pressure and/or strain in an optical fibre of the distributed optical fibre sensor.

4. A method according to claim 1 wherein the step of transforming each pixel value of pixels in the processed image to values to provide a plurality of measurement values with reduced noise, comprises transforming each pixel value of pixels in the processed image to values having units of measurements equivalent to the units of the measurement values acquired in step (a).

5. A method according to claim 1 wherein the step of transforming each measurement value in the matrix to a corresponding pixel value on a predefined scale of pixel values, comprises performing a linear transformation, non-linear transformation or inverse transformation, to a corresponding value on a predefined scale of pixel values.

6. A method according to claim 1 wherein the step of transforming each entry of the matrix to a corresponding value on a predefined scale of pixel values comprises transforming each entry of the matrix to a corresponding value on the predefined scale of pixel values, wherein the highest measured value is mapped to the highest value in the predefined scale of pixel values, and the lowest measured value is mapped to the lowest value in the predefined scale of pixel values.

7. A method according to claim 6 wherein the measured values having values between the highest and lowest measured values are mapped to corresponding relative pixels values in the predefined scale of pixel values,
wherein for each of said measured values the corresponding relative pixels value is such that the ratio of that measured value pixel value to the highest measured value acquired in step (a) is equal to the ratio between the corresponding relative pixel value and the highest pixel value on the predefined scale of pixel values.

8. A method according to claim 4 wherein the predefined scale of pixel values is a scale of color intensities, or is a colour scale.

9. A method according to claim 1 wherein the step of transforming each pixel value of the processed image back to measurement values, comprises mapping the highest pixel value in the processed image to the highest measured value acquired in step (a), and mapping the lowest pixel value in the processed image to the lowest measured value acquired in step (a).

10. A method according to claim 9 wherein, for each of the pixel values of each of the pixels in the processed image which are between the highest and lowest pixel values to a measured values, mapping that pixel value to a corresponding measurement value wherein the corresponding measurement value is such that the ratio of the pixel value to highest pixel value is equal to the ratio of the corresponding measurement value to the highest measured value acquired in step (a).

11. A method according to claim 1 wherein the step of acquiring a plurality of measurement values using a distributed optical fibre sensor, comprises, using a Brillouin distributed optical fibre sensor to acquire a plurality of Brillouin response values, at different frequency shifts between the pump signal and backscattered signal, at different positions along an optical fibre of the Brillouin distributed optical fibre sensor; and
wherein the step of arranging the plurality of measurement values in a matrix having at least two dimensions comprises arranging the acquired Brillouin response values in a matrix having two dimensions, and
wherein the acquired Brillouin responses are positioned in the matrix according the frequency shifts between the pump signal and backscattered signal and the position along an optical fibre at which that Brillouin response was measured.

12. A method according to claim 1 wherein the acquiring plurality of measurement values using a distributed optical fibre sensor comprises acquiring the response of Rayleigh backscattering, and the step of arranging the plurality of measurement values in a matrix having at least two dimensions comprises arranging the acquired response of Rayleigh backscattering, in a matrix having two dimensions, wherein each response of Rayleigh backscattering is positioned in the matrix according to position along the sensing fibre at which said response of Rayleigh backscattering was measured and according to an optical frequency at which said response of Rayleigh backscattering was measured.

13. A method according to claim 1 wherein the method further comprises the step of recording the time over which all of the plurality of measurement values are acquired.

14. A method according to claim 13 wherein the method further comprises the step using said image and the recorded time at which each measurement value is acquired to generate an 3-D image matrix which is representative of a 3-D image or video ;
and wherein the step of processing the image using an image processing algorithm, comprises processing the 3-D image or video using an image or video processing algorithm.

15. A method according to claim 13 wherein the acquiring plurality of measurement values using a distributed optical fibre sensor comprises acquiring response of Raman backscattering, and the step of arranging the plurality of measurement values in a matrix having at least two dimensions comprises arranging the acquired response of Raman backscattering in a matrix having two dimensions, wherein said recorded time is one of said at least two variables associated with that respective measurement value.

16. A method according to claim 13 wherein the acquiring plurality of measurement values using a distributed optical fibre sensor comprises acquiring the response of Rayleigh backscattering, and the step of arranging the plurality of measurement values in a matrix having at least two dimensions comprises arranging the acquired response of Rayleigh backscattering in a matrix having two dimensions, wherein said recorded time is one of said at least two variables associated with that respective measurement value.

17. A method according to claim 1 wherein the image or video processing algorithm comprises an algorithm based on Gaussian Filtering, Non Local Means, Discrete Cosine Transform and/or Discrete Wavelets Transform.

18. A method according to claim 1 further comprising a step of applying a delay to one or more of the plurality of measurement values.

19. A method according to claim 1 further comprising the steps of,
retrieving stored measurement values from a memory;
arranging the retrieved measurement values in a matrix having at least two dimensions;
transforming each retrieved measurement value in the matrix to a corresponding pixel value on a predefined scale of pixel values to form a second image;
processing the image using an image processing algorithm so as to reduce noise in the image to provide a second processed image;
transforming each pixel value of pixels in the second processed image to values to provide a plurality of measurement values with reduced noise.

20. A distributed optical fibre sensor comprising a processor which is operable to perform steps according to claim 1.
